(19) United States
(12) Patent Application Publication
(10) Pub. No.: US 2017/0254073 A1
(43) Pub. Date: Sep. 7, 2017

(54) Kit for making a panel structure for an external side wall or a covering of a building, and building provided with such panel structure

(71) Applicant: DOTT. GALLINA S.r.l., Torino (IT)

(72) Inventor: Daniel Gallina, Torino (IT)

(21) Appl. No.: 15/449,482

(22) Filed: Mar. 3, 2017

(30) Foreign Application Priority Data
Mar. 4, 2016 (IT) 102016000023117

(51) Int. Cl. E04B 2/96; E06B 3/06; E04B 2/72

(52) U.S. Cl. CPC E04B 2/96; E04B 2/721; E06B 3/06

(57) ABSTRACT

A kit is provided for making a panel structure for an external side wall or a covering of a building; the kit has a plurality of section elements elongated along a longitudinal axis, designed to be fastened to a support and having respective seats which are open at the top and at their longitudinal ends and are designed to form, together, a longitudinal channel; the kit is provided with panels, engaging the channel, and with a seal made of flexible material and having a strip portion to cover at least two consecutive joint zones between the section elements.

### PRIORITY CLAIM

This application claims priority from Italian Patent Application No. 102016000023117 filed on Mar. 4, 2016, the disclosure of which is incorporated by reference.

### TECHNICAL FIELD

The present invention concerns a kit for making a panel structure for an external side wall or a covering of a building.

### BACKGROUND OF THE INVENTION

In the external side walls of buildings, in particular in commercial and industrial premises, panel structures are provided having a row of section elements and a series of panels or sheets which are coupled to said section elements and, for example, are defined by transparent or semi-transparent modules. The panels are abutted side by side to one another so as to define a continuous facade or covering.

These types of application entail the problem of condensation which tends to form in honeycomb type panels and, above all, the problem of sideways rain on the external facades and on the covering of the building. In fact, the water tends to accumulate in the section elements even though the latter are provided with a series of drainage holes to discharge said water to the outside.

In particular, the water tends to run unpredictably in the section elements in a longitudinal direction, and drops both outside and inside the building, at the joint zones between the section elements. Therefore, as time passes, the water that has seeped into the building tends to damage the internal walls and forms undesired dark marks below the joint zones between the sections.

To remedy these drawbacks, silicone or a similar sealant is applied at the joint zones between the section elements, during assembly of the latter, to obtain a seal in said zones. Alternatively to the silicone, a connecting plate is fitted at each joint zone, so as to define a sort of patch that prevents the water from leaking out, favouring longitudinal flow and consequent drainage to the outside.

However, these solutions require manual skill and experience to be applied, and relatively long installation times. Furthermore, ordinary sealants tend to lose their effectiveness over time, due to thermal expansion.

Another aspect to be considered consists in the fact that, in compliance with building regulations enforced in some countries, the section elements are fixed to the wall by means of additional brackets, to prevent the water penetrating into the wall through the holes of the fastening system. In particular, the brackets are fixed to the section elements by means of horizontal holes and screws, which are higher than the area where the water tends to accumulate and, therefore, do not create outlet points from which the water could infiltrate the wall. This type of fastening is complex and costly to install; therefore, it is preferable to find a simpler alternative that prevents the water from infiltrating the wall.

### SUMMARY OF THE INVENTION

The object of the present invention is to provide a kit for making a panel structure for an external side wall or a covering of a building, which solves the above drawbacks in a simple inexpensive manner.

According to the present invention a kit is provided for making a panel structure for an external side wall or a covering of a building, as defined in claim 1.

The present invention further relates to a building according to claim 6.

### BRIEF DESCRIPTION OF THE DRAWINGS

The invention will now be described with reference to the accompanying drawings, which illustrate a non-limiting embodiment thereof, wherein:

FIG. 1 is a cross section which shows part of an external side wall provided with a panel structure made by means of the kit of the present invention;

FIG. 2 is a diagram which shows, in perspective, the panel structure of FIG. 1;

FIG. 3 illustrates, in perspective and with parts removed for clarity, a detail of the panel structure of FIGS. 1 and 2;

FIG. 4 is a cross section of a seal forming part of the kit of the present invention;

FIGS. 5 to 8 are similar to FIG. 1 and show, on a reduced scale, respective variations of the present invention; and

FIG. 9 shows, in perspective and with parts removed for clarity, the variation of FIG. 8.

### DETAILED DESCRIPTION OF THE INVENTION

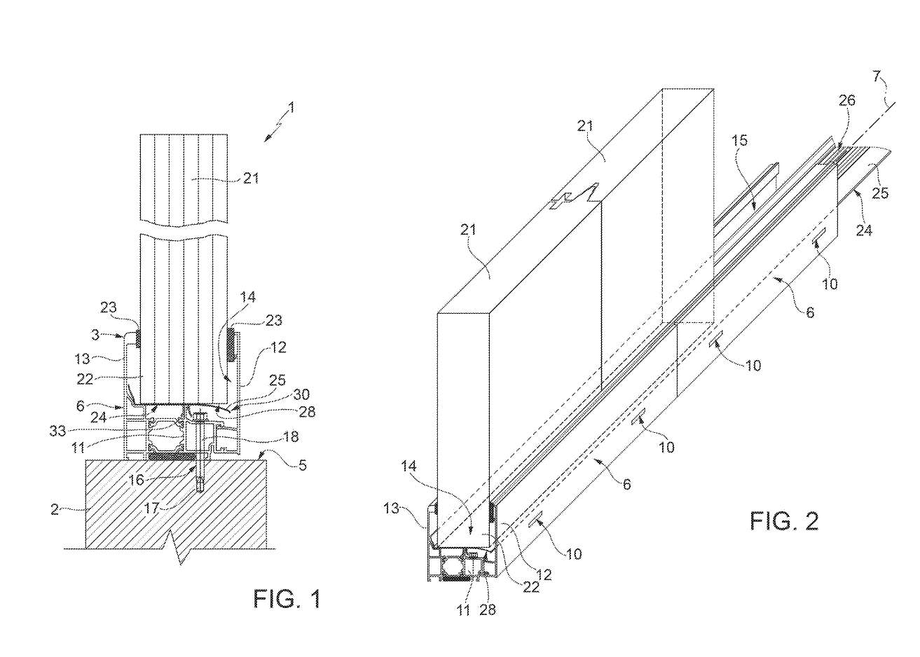

In FIG. 1, the reference number 1 indicates, overall, an external side wall of a building (partially illustrated). In particular, the wall 1 is vertical, but could also have an inclination with respect to the vertical. The wall 1 comprises a wall 2 and a panel structure 3 which, in particular, engages and closes an opening, defined at the bottom by a horizontal surface 5 of the wall 2.

As shown in FIG. 2, the structure 3 comprises a row of section elements 6, which rest on the surface 5 and are aligned with one another along a longitudinal axis 7. Each of the section elements 6 consists of a set of pieces, which are fixed with respect to one another, are preferably made of aluminium or an aluminium alloy and are obtained by means of extrusion. Alternatively, the section elements 6 can be made of different materials, for example plastic (PVC, polyester, etc . . . ) or sheet metal, and/or they can be obtained by means of different processes, for example by moulding or by cold or hot bending.

The cross section, orthogonal to the axis 7, is the same for all the section elements 6 and is constant along the axis 7, if we exclude the presence of drainage holes 10 spaced longitudinally from one another. Said cross section is essentially defined by a U shape, so that each section element 6 comprises a base portion 11, an external wall 12 and an internal wall 13. The walls 12 and 13 project upwards from opposite longitudinal edges of the portion 11 and horizontally face each other. Therefore, the walls 12, 13 and the portion define a seat 14, which is open at the top and at the longitudinal ends of the section element 6. The seats 14, together, form one single channel 15 which is continuous and rectilinear along the axis 7.

In particular, the holes 10 are made on the external wall 12 at the lower end of the seat 14. Alternatively, or in combination with this feature, also the walls constituting the portion 11 can be provided with drainage holes longitudinally spaced from one another.

With reference to FIG. 1, the structure 3 further comprises a plurality of fastening members 16, which fix the section elements 6 to the wall 2. In particular, each fastening member 16 comprises a plug 17 inserted in the wall 2 and a screw 18 which engages a corresponding hole in the portion 11 and is screwed into the plug 17 so as to secure the portion 11 against the surface 5.

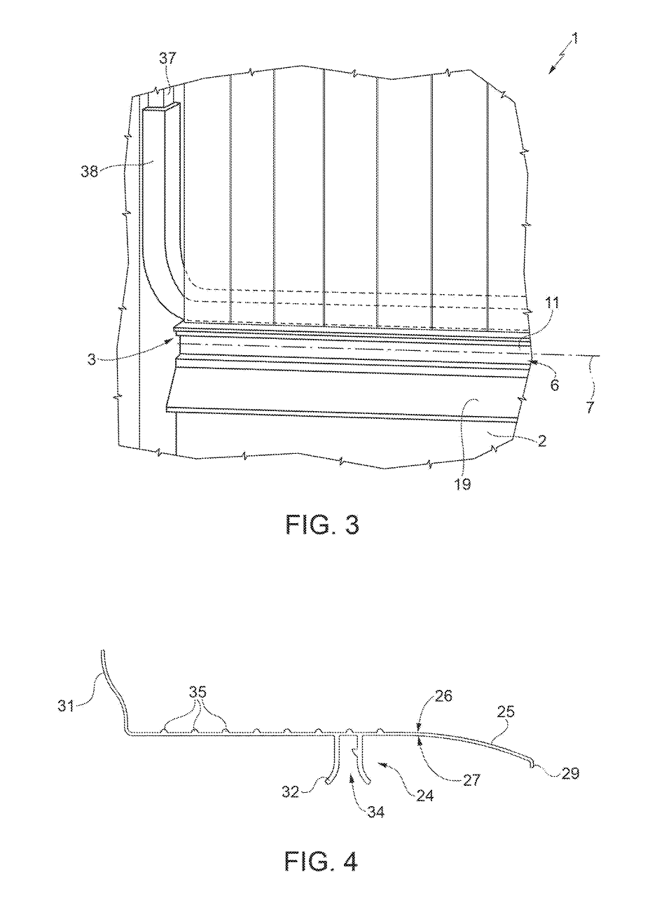

FIG. 3 shows that the section element 6 preferably comprises a drip profile 19 (partially illustrated) to ensure that the drained water, coming out of the holes 10, runs well away from the external face of the wall 2; and/or a gutter (not illustrated) to collect the drained water.

In particular, the gutter and/or the drip profile 19 project outwards from the external wall 12 (not illustrated in FIG. 3), starting from a position below the holes 10, so as to prevent the drained water from dropping directly onto the wall 2. For example, the gutter and/or the drip profile 19 comprise a longitudinal end edge which is vertically blocked between the portion 11 and the surface 5, in a manner not illustrated in detail.

With reference to FIG. 2, the structure 3 further comprises a plurality of panels 21, which are vertical and coplanar with one another, are abutted to one another along the axis 7 so as to form a continuous panelling and have respective bottom end portions 22 which engage the channel 15 substantially without play in a horizontal direction orthogonal to the axis 7.

Spacer elements or sealing elements 23 can be arranged between the panels 21 and the walls 12,13.

Preferably, at least some of the panels 21 have the same standard dimensions. In the specific case illustrated, the panels 21 are defined by respective plates or modules made of polycarbonate, which are transparent or semi-transparent so as to define a window of the building.

According to the present invention, the structure 3 further comprises a seal 24, which is made of flexible material, for example polyethylene, and comprises a strip portion 25 which is continuous along the axis 7 and engages the seats 14 so as to cover the joint zones between the portions 11. Essentially, the strip portion 25 has a length greater than that of a single seat 14, so as to be used to cover at least two consecutive joint zones. In particular, the strip portion 25 engages the whole channel 15: in this way, it is possible to store the seal 24 in the form of a coil, unwind said coil during assembly of the structure 3 so as to arrange the seal 24 directly inside the channel 15 and then cut the seal 24 to the desired length.

As can be seen in FIG. 2, the strip portion 25 has a top face 26, vertically facing the portions 22, and a bottom face vertically facing the portion 11. The portions 22 are delimited at the bottom by a surface 28 (FIGS. 1 and 2) which vertically overlaps the face 26, so that it is entirely covered by the face 26. In this way, any water that runs along the portions 22 does not drop directly onto the portions 11 but drops onto the strip portion 25 that guides the water towards the holes 10 and prevents the water passing through the joint zones between adjacent portions 11.

Advantageously, the strip portion 25 has a longitudinal edge 29 which, in a horizontal direction orthogonal to the axis 7, is spaced from the external wall 12, so that there is an empty space or gap 30 (FIG. 1) allowing the water to drop from the edge 29 onto the portion 11 in the vicinity of the holes 10.

At the opposite end of the edge 29, the strip portion 25 terminates in a tongue 31, which is not covered by the portions 22 and rests against the walls 13. In this way, by dripping onto the tongue 31, the water does not go directly onto the portion 11 but is guided towards the holes 10. In particular, the tongue 31 is folded upwards with respect to the remaining part of the strip portion 25, i.e. it forms a fold which is arranged at a longitudinal edge of the portions 22.

The seal 24 further comprises at least one appendage 32 which projects from the face 27 and is coupled to a corresponding vertical tongue 33 (FIG. 1) forming part of the portion 11. The coupling between the tongue 33 and the appendage 32 defines a reference for correctly positioning the seal 24 in the channel 15, in a horizontal direction orthogonal to the axis 7, during assembly.

Preferably, the appendage 32 defines a retaining seat 34 which is open at the bottom and is engaged by the tongue 33. Advantageously, the appendage 32 and therefore the retaining seat 34 are continuous along the axis 7, hence the seal 24 can be produced by extrusion.

In the particular example illustrated (FIG. 1), the faces 27 and 26 rest against the portions 11 and 22 respectively, therefore the strip portion 25 remains vertically clamped between the panels 21 and the section elements 6. As can be seen in FIG. 4, preferably, a plurality of longitudinal and parallel ribs (indicated by reference number 35) are provided on the face 26, in order to maintain the panels 21 slightly raised with respect to the face 26. This allows the condensate accumulated on the cells of the panels 21 to flow out and down the face 26, allowing said cell to breathe.

With reference to FIG. 3, the longitudinal ends of the structure 3 are defined by respective uprights 37, only one of which is illustrated. Advantageously, the seal 24 has two ends 38 which are opposite each other and are folded upwards with respect to the remaining horizontal part, so that they are arranged between the panels 21 and the uprights 37. In this way, the portion 38 forces the water that has accumulated in the section elements 6 to exit solely through the drainage holes 10, preventing an exit at the end of the structure 3 in the joint zone between the uprights 37 and the channel 15.

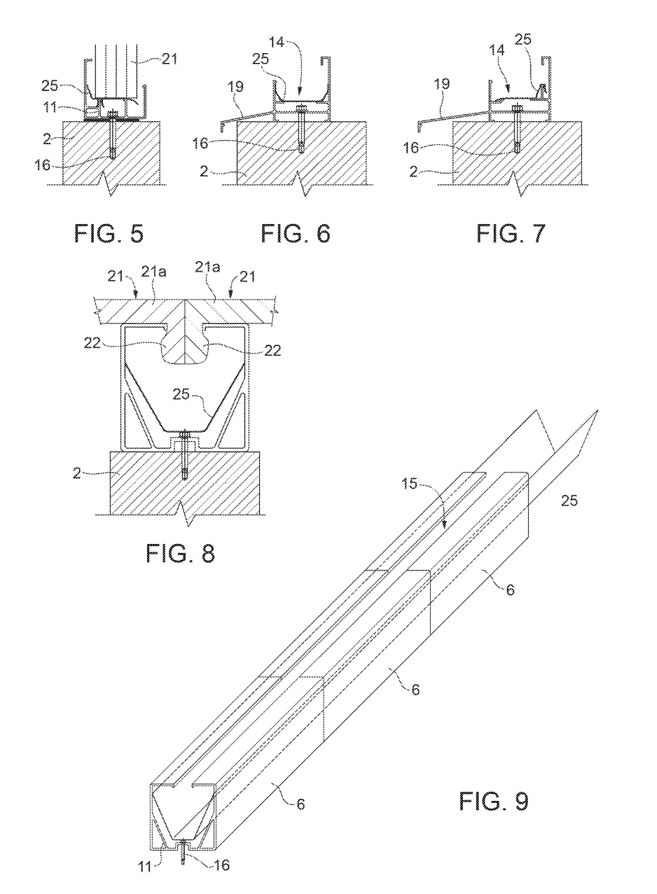

FIGS. 5 to 8 show respective variations, the component parts of which are indicated, where possible, by the same reference numbers as those used in FIG. 1. Said variations indicate that the cross section of the section elements 6 and/or the shape of the strip portion 25 after insertion in the channel 15 may be different from what is shown in FIG. 1.

Furthermore, as can be seen in the variation of FIG. 6 and in the variation of FIGS. 8 and 9, the seal 24 could be defined solely by the strip portion 25, without any appendage 32.

Furthermore, the strip portion 25 is arranged in the channel 15 so as to form a U shape, i.e. so that it too takes on a channel or gutter configuration to collect the water.

Furthermore, as can be seen in FIG. 8, the structure 3 can be used in a covering of a building (for example a horizontal covering) and not for the wall 1 described above. In this case, the panels 21 comprise respective flat sheets 21a, while the portions 22 are defined by appendages that project downwards from the ends of the sheets 21a and, preferably, have a shape and size such as to be snap-hooked into the top openings of the seats 14.

Furthermore, the section elements 6 can be fixed to a support defined by a building structure different from the wall 2, for example to a horizontal beam.

From the above it is evident that the section elements 6, the fastening members 16, the panels 21 and the seal 24 define part of a kit which can be supplied to building firms for installing the structure 3. In particular, one single seal 24 is provided in common with at least some of the section elements, so as to simplify production and installation of the seal 24. In fact, as mentioned above, the seal 24 can be installed after fastening the section elements 6 and forming the channel 15, unwinding said seal 24 from a coil, in a relatively quick manner, and inserting it manually into the seats 14 on the bottom of the channel 15. During said insertion, the strip portion 25 adapts to the cross section of the channel 15, since it is made of flexible material. Furthermore, as mentioned above, the positioning of the seal is relatively simple, quick and accurate, due to the flexibility of the material and possible presence of the appendage 32.

At the same time, the strip portion 25 covers all the screws 18, and not only the joint zones between the portions 11, so that the plugs 17 are protected from any infiltration of water. This solution consequently avoids different fastening systems, which in other known solutions are provided on the outside of the section elements 6, are generally more complex and can compromise the aesthetics of the structure 3.

Further advantages have been illustrated above or are evident to a person skilled in the art on the basis of the construction characteristics described with reference to the attached figures.

Lastly, from the above it is evident that modifications and variations that do not depart from the protective scope of the present invention, as defined in the following claims, can be made to the kit and to the wall 1 described above with reference to the attached figures.

In particular, as indicated above, the cross section and/or the material of the section elements 6 and/or of the seal 24 may be different from the description provided by way of example.

1. A kit for making a panel structure for an external side wall or a covering of a building, the kit comprising:
a plurality of section elements elongated along a longitudinal axis, comprising respective base portions designed to be rested on a support and having respective seats, which are open at the top and at their longitudinal ends; said section elements being designed to be longitudinally aligned and abutted to each other so as to define a longitudinal channel formed by the combination of said seats;
a fastener for fastening said section elements to said support;
plurality of panels comprising respective ends that have a shape and size such as to engage, in use, said seats; and
at least one seal made of a flexible material;
wherein said seal comprises a continuous strip portion, that is longer than each said seat along said longitudinal axis and has a top face designed to be arranged in a position vertically facing said ends and a bottom face designed to be arranged in a position vertically facing said base portions.

2. The kit according to claim 1, wherein said top face is larger in size than said ends in a horizontal direction orthogonal to said longitudinal axis.

3. The kit according to claim 1, wherein said seal comprises at least one appendage that projects from said bottom face.

4. The kit according to claim 3, wherein said at least one appendage defines a retention seat designed to be engaged by a vertical tongue of said section elements.

5. The kit according to claim 1, wherein said top face is provided with a plurality of parallel longitudinal ribs.

6. A building comprising an external side wall or a covering having a support and a panel structure, the panel structure comprising:
a row of section elements aligned and abutted to each other along a longitudinal axis, comprising respective base portions resting on said support and having respective seats, which are open at the top and at their longitudinal ends, are defined below by said base portions and form a longitudinal channel; said base portions defining respective joint zones between each other;
fasteners that fasten said section elements to said support;
a plurality of panels comprising respective ends engaging said longitudinal channel; and
at least one seal made of a flexible material;
wherein said seal comprises a continuous strip portion that covers at least two consecutive joint zones along said longitudinal axis and has:
a top face, vertically facing said ends, and
a bottom face vertically facing said base portions.

7. The building according to claim 6, wherein said ends have a bottom surface entirely covered by said top face.

8. The building according to claim 6, wherein said seal also comprises at least one appendage that projects from said bottom face.

9. The building according to claim 8, wherein said at least one appendage defines a retaining seat engaged by a vertical tongue of said section elements.

10. The building according to claim 6, wherein said panel structure comprises at least one vertical upright arranged at a longitudinal end of said row, and in that said continuous strip portion comprises an end portion that is folded upwards so as to be arranged between said vertical upright and said panels.

11. The building according to claim 6, wherein said continuous strip portion rests against said base portions and said ends.
